(19) United States
(12) Patent Application Publication
(10) Pub. No.: US 2008/0127849 A1
(43) Pub. Date: Jun. 5, 2008

(54) Method Of Controlling Quality Of Printed Images Of Color Printing Press And Apparatus For Controlling Quality Of Printed Images

(76) Inventor: Hiroshi Sugimoto, Fuchu-shi (JP)

Correspondence Address: PERKINS COIE LLP, P.O. BOX 2168, MENLO PARK, CA, 94026, US

(21) Appl. No.: 11/946,516

(22) Filed: Nov. 28, 2007

(30) Foreign Application Priority Data
Nov. 30, 2006 (JP) 2006-323344

(51) Int. Cl. B41F 33/00

(52) U.S. Cl. 101/484

(57) ABSTRACT

An object is to securely prevent incorrect reproduction of a highlight portion and an intermediate portion due to the change in condition of the printing press and incorrect reproduction of a shadow portion. The printing press includes a measuring means 12 for measuring the solid densities and the gray balance, of a printed color print image; a computing means 13 for computing respectively the differences between the solid density values and the gray balance measured by the measuring means 12 and their target values; a correction-value-computing means 14 for computing the correct values based on their differences respectively computed by the computing means 13; and an ink-supply-amount-adjusting means 15 for adjusting the amount of the ink of each of the basic colors to be supplied through each of plural ink fountain keys, based on the correction values computed by the correction-value-computing means 14.

### CROSS REFERENCE TO RELATED APPLICATION

This application claims priority from Japanese Patent Application No. 2006-323344, which is incorporated herein by reference.

### BACKGROUND OF THE INVENTION

1. Field of the Invention

The present invention relates to a method of controlling the quality of printed images of a color printing press by controlling the amounts of inks of basic colors, respectively, and an apparatus for controlling the quality of printed images.

2. Related Art

A known color printing press includes plural ink fountains that respectively store plural basic colors (four typical colors: cyan (C), magenta (M), yellow (Y) and black (Bk)) different from each other, and plural ink fountain keys located adjacent to each other to be capable of adjusting the amounts of inks supplied respectively from the ink fountains, in which plural basic color inks whose ink supply amounts each adjusted by each ink fountain key are respectively supplied onto plural printing plates provided corresponding to the plural ink fountains, and plural basic color images respectively formed with the plural basic color inks by the plural printing plates are successively printed on substrates, thereby obtaining printed matters with the color print images thereon.

For printing printed matters by the thus arranged color printing press, the quality of printed images are usually controlled. For example, before the printing press runs, the hue (mainly the ink amount) of the color print image to be printed is adjusted and the color matching to the color print image of printed matters is performed in order to prevent the hue of the color print image printed in press run quantities from being varied from the hue of a color print image of a printed matter (so called an OK sheet) with its colors matched.

Among various methods of controlling the quality of printed images that control the quality of printed images (e.g., the hue (mainly the ink amount) of a color print image of printed matters), there are a method that perform the solid density control and a method that performs the gray control.

The solid density control is to control the hue by, for example, the ink film thickness (ink solid density) of a color print image to be printed, and specifically controls respectively the amounts of plural basic color inks respectively supplied from plural ink fountains by plural ink fountain keys based on the solid densities of plural basic color images that together make up a color print image to be printed (e.g., cf. Patent Document 1).

The gray control is to control the hue by, for example, the ink densities of the separated CMY colors of gray, and specifically, control the amounts of plural basic color inks respectively supplied from plural ink fountains by plural ink fountain keys based on the gray balance for use in correcting the color balance between the plural basic color images. More specifically, there is printed a gray control patch formed by plural halftone images overlapped each other, each having a certain tone value, and respectively correspond to plural basic color images, (specifically, a single gray patch formed by plural halftone images of C, M and Y each having a certain tone value (Bk is controlled based on the solid density)). This gray control patch is designed to control the color balance between the plural basic color images. Then, plural standard spectral densities respectively corresponding to the plural basic color images are previously set, then plural spectral densities for the gray control patch respectively corresponding to plural basic color images are measured, and the amounts of the plural basic color inks supplied respectively from the plural ink fountains by the plural ink fountain keys are respectively controlled so as to enable the measured plural spectral densities of the gray control patch to be respectively brought at the previously set plural standard densities (e.g., cf. Patent Document, 2).

In controlling the quality of a color print image in this manner, as long as the amount of ink in a printing press (the amount of ink fed out of each ink fountain) is not changed, the hue of the color print image to be printed is not basically changed. However, depending on various factors, such as environments of a printing press, a press room accommodating the printing press and the like (e.g., the room temperature of the press room), the condition (e.g., ink viscosity) of the printing press may be changed and hence the behavior of dot gain or the like may be changed due to the degree of ink viscosity or the like in a color print image. In this case, the hue may be varied even if the ink amount is kept substantially constant.

In the solid density control, when dot gain or the like has been changed due to changes in the condition of a printing press (ink viscosity or the like), the hue of a shadow portion (a portion having a large tone value) is almost kept unchanged and thus the hue control can be made for the shadow portion. However, the hues of a highlight portion (a portion having a relatively small tone value), which is easy to be influenced by the change in (lot gain or the like, and an intermediate portion (a portion having a tone value of around 50%) are easy to be varied, which may cause a disadvantage in that the highlight portion and the intermediate portion are not correctly reproduced. Contrarily to this, in the gray control, even if dot gain has been changed, the hues of a highlight portion and an intermediate portion are almost kept unchanged so that the hue control can be made for the highlight portion and the intermediate portion, however, the hue of a shadow portion, which is difficult to be influenced by the change in dot gain or the like, is easy to be varied, which may cause a disadvantage in that the shadow portion is not correctly reproduced.

| | |
|---|---|
| [Patent Document 1] | Japanese Patent No. 3384769 |
| [Patent Document 2] | Japanese Patent No. 2505434 |

### SUMMARY OF THE INVENTION

In consideration of the above problems, it is an object of the present invention to provide a method of controlling the quality of printed images of a color printing press and an apparatus for controlling the quality of printed images, which are capable of securely preventing incorrect reproduction of a highlight portion and an intermediate portion due to the change in condition of the printing press (e.g., ink viscosity), and incorrect reproduction of a shadow portion.

According to one aspect of the present invention, there is provided a method of controlling the quality of printed images of a color printing press including:

adjusting by using ink fountain keys the amounts of printing inks of plural basic colors different from each other to be supplied from plural ink fountains with the printing inks stored therein;

supplying the basic color inks adjusted respectively by the ink fountain keys on plural printing plates provided corresponding to the plural ink fountains; and

printing successively plural basic color images formed respectively by the plural basic color inks onto a substrate, thereby printing a color print image on the substrate, the method further including:

measuring the solid densities of the plural basic color images, respectively, and measuring the gray balance for use in correcting the color balance between the plural basic color images;

computing the differences between the measured plural solid density values and preset plural target solid density values and computing the difference between the measured gray balance value and a preset target gray balance value; and

adjusting the amount of the ink of each of the basic colors to be supplied by each of the plural ink fountain keys.

According to another aspect of the present invention, there is provided an apparatus for controlling the quality of printed images of a color printing press including:

plural ink fountains for respectively storing printing inks of plural basic colors different from each other; and

plural ink fountain keys for each adjusting the amount of each of the printing inks to be supplied from the ink fountains;

wherein the basic color printing inks whose ink supply amounts each adjusted by each ink fountain key are respectively supplied onto plural printing plates provided corresponding to the plural ink fountains, and plural basic color images respectively formed with the plural basic color inks by the plural printing plates are successively printed on a substrate, thereby printing a color print image on the substrate;

the apparatus further including a control section, the control section including:

a measuring means for measuring the solid densities of the plural basic color images, respectively, and measuring the gray balance for use in correcting the color balance between the plural basic color images;

a computing means for computing the differences between the plural solid density values measured by the measuring means and preset plural target solid density values and computing the difference between the gray balance measured by the measuring means and a preset target gray balance value;

a correction-value-computing means for computing the correct values based on the plural solid density differences computed by the computing means and the gray balance difference; and

an ink-supply-amount-adjusting means for adjusting the amount of the ink of each of the basic colors to be supplied through each of the plural ink fountain keys, based on the correction values computed by the correction-value-computing means.

The aforesaid method may further include:

computing the brightness ΔL, and the hues Δa and Δb from a target Lab value and a Lab value obtained by measuring a printed color print image, by using a gray Lab value as a gray balance value;

converting the computed three ΔL, Δa and Δb respectively into halftone density differences and then converting the converted three halftone density differences respectively into solid density differences;

summing the converted three solid density differences for the gray control and the plural solid density differences for the solid density control computed from the measured plural solid density values and the plural target solid density values and averaging the summed values to yield average values; and

adjusting the amount of the ink of each of the basic colors to be supplied through each of the plural ink fountain keys, based on the computed average values.

In the aforesaid apparatus, it is possible that:

the gray balance value is a gray Lab value;

the computing means for gray control for computing the difference between the measured gray valance value and the target gray balance value is a ΔLΔaΔb computing means for computing the brightness ΔL, and the hues Δa and Δb from the difference between a target Lab value and a Lab value obtained by measuring a printed color print image;

the correction-value-computing means is a correction-solid-density-difference-computing means for computing the correction solid density difference;

the correction-solid-density-difference-computing means includes:

a halftone-density-difference-converting means for converting the three ΔL, Δa and Δb computed by the ΔLΔaΔb computing means respectively into halftone density differences;

a solid-density-difference-converting means for converting the three halftone density differences converted by the halftone-density-difference-converting means respectively into solid density differences; and

an average-value-computing means for summing the three solid density differences for the gray control converted by the solid-density-difference-converting means and the plural solid density differences for the solid density control computed by the computing means, and averaging the sum to yield average values designated as correction solid density differences.

Thus, it is possible to reflect the correction value, which has been determined from at least three differences of the differences between plural target solid density values and plural solid density values obtained by measuring an actually printed matter and the difference between a target gray balance value and a gray balance value obtained by measuring an actually printed matter, in adjusting the amount of the printing ink of each of the basic colors to be supplied through each of the plural ink fountain keys. Therefore, even if the condition (e.g., ink viscosity) of the printing press has been changed, at least three values of the plural solid density values and the gray balance value do not fall out of their previously set, corresponding permissible ranges, and thus constantly fall within the permissible ranges. Thus, it is possible to provide a method of controlling the quality of printed images of a color printing press and an apparatus for controlling the quality of printed images, which are capable of securely preventing incorrect reproduction of a highlight portion and an intermediate portion, and incorrect reproduction of a shadow portion.

According to the present invention, it is not to take the difference between the halftone density value of a printed matter after printing and a target halftone density value, but to compute the brightness ΔL, and the hues Δa and Δb from a Lab value of a printed matter after printing and a target gray Lab value. Thus, the gray balance can be made with high accuracy. It is also possible to achieve easy and prompt control by converting three halftone density differences determined in the gray control respectively into solid density differences and averaging the converted three solid density differences and the plural solid density differences determined in the solid density control. Specifically, in a case in which, without converting into three solid density differences, for data control, there are provided one table showing the relationship between three halftone density differences for gray control and the opening degrees of the ink fountain keys, and one table showing the relationship between plural solid density differences for solid density control and the opening degrees of the ink fountain keys, respectively, and values extracted from these two tables are converted into the amounts of inks to be supplied, two tables are required to be provided. In comparison with this case, by employing the averaging step or averaging means, both the controls can be made by the common table and thereby easy and prompt control can be achieved.

Herein, by the solid density is meant a color density of a color printed with ink covering 100% of a substrate or printing sheet. By the halftone density is meant the degree of the thickness of a color determined based on the ratio of plural colors occupied in a unit area in halftone.

### BRIEF DESCRIPTION OF THE DRAWINGS

FIG. 1 is a schematic structural view of a color printing press that performs a method of controlling the quality of printed images of the color printing press.

FIG. 2(a) is a model view illustrating an enlarged essential portion of an ink supply section and its periphery.

FIG. 2(b) is a partial model view illustrating in exaggerated form the gap between a hereinafter-described ink fountain key and an ink fountain roller in the ink supply section.

FIG. 3 is a block diagram illustrating the structure of a control section provided with a solid density control means and a gray control means.

FIG. 4 is a flowchart for determining an appropriate solid density difference from the solid density difference determined by the solid density control and the solid density difference determined by the gray control.

FIG. 5(a) is a graph showing the Y-halftone density difference relative to Δb, and FIG. 5(b) is a graph showing ΔL, Δa and Δb relative to the Y-halftone density difference.

FIG. 6(a) is a graph showing the M-halftone density difference relative to Δa1, and FIG. 6(b) is a graph showing the Y2-halftone density difference relative to the M-halftone density difference.

FIG. 7(a) is a graph showing ΔL, Δa and Δb relative to the CMY equivalent amount-halftone density difference, and FIG. 7(b) is a graph illustrating the CMY equivalent amount-halftone density difference relative to ΔL.

FIG. 8(a) is a graph showing the solid density difference relative to the Y-halftone density difference, and FIG. 8(b) is a graph showing the solid density difference relative to M-halftone density difference.

FIG. 9 is a flowchart for determining the opening degree of an ink fountain key from the halftone density difference determined by the solid density control and the solid density difference determined by the gray control.

### DETAILED DESCRIPTION OF THE PREFERRED EMBODIMENT

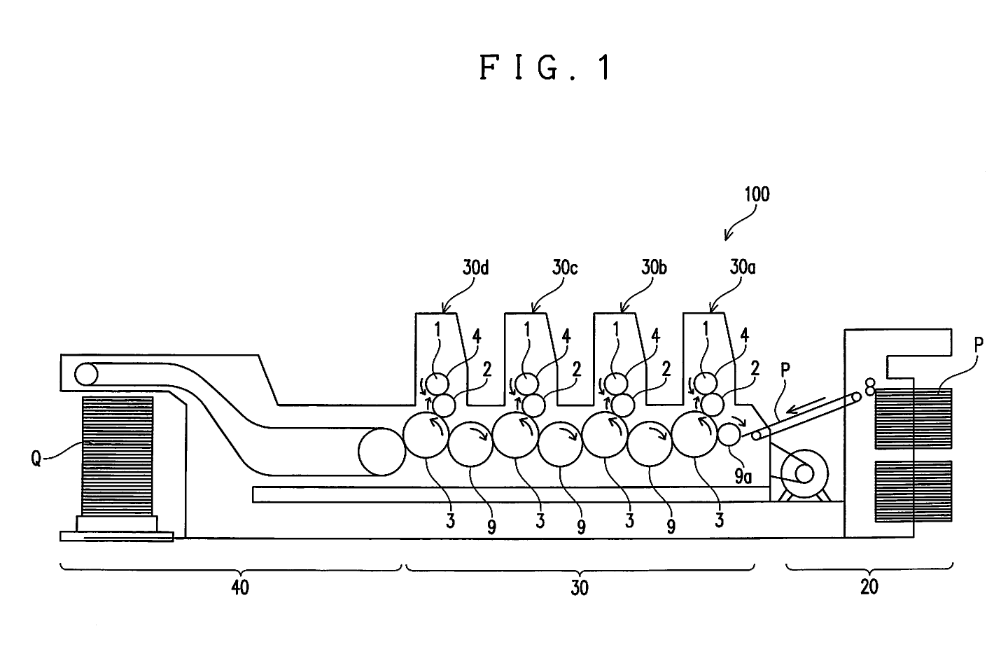

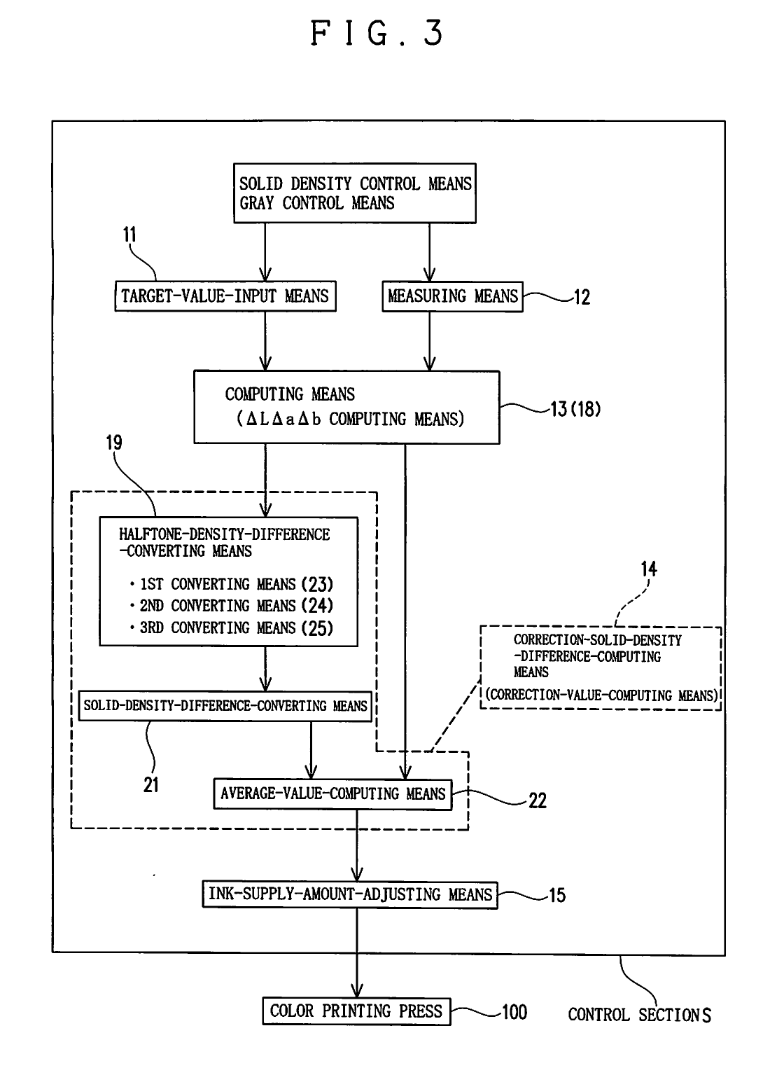

Now, the description will be made for an embodiment of the present invention with reference to the drawings attached hereto. FIG. 1 is a view illustrating a schematic structure of an example of a color printing press 100 in an example of a color printing system for carrying out a method of controlling the quality of printed images of a color printing press of the present invention. The color printing system has a control section S of FIG. 3 (which will be hereinafter described), as well as the color printing press 100. In FIG. 1, the same reference numerals will be allocated to parts and members that each have substantially the same structure and the same function.

As illustrated in FIG. 1, the color printing press 100 is to print a color print image on a substrate P (a printing sheet herein) by successively printing basic color images of C, M, Y and B respectively formed with printing inks of colors different from each other, herein inks of four basic colors Cyan (C), Magenta (M), Yellow (Y) and Black (Bk) on the printing sheet P. The color printing press 100 includes a sheet supply section 20, a printing section 30 and a sheet discharge section 40. The sheet supply section 20 can supply printing sheets P to the printing section 30. The printing section 30 can print on the printing sheets P supplied from the sheet supply section 20, and includes plural printing units (herein, four printing units 30a-30d, at which images of basic colors C, M, Y and Bk are printed thereon). The sheet discharge section 40 can discharge printed matters Q printed at the printing section 30. In this printing press 100, the printing sheets P are supplied from the sheet supply section 20 to the printing section 30, and the supplied printing sheets P are printed at the printing units 30a-30d of the printing section 30, respectively, and then the printed matters Q are discharged through the sheet discharge section 40.

The printing units 30a-30d of the printing section 30 each have a plate cylinder 1, a rubber cylinder 2 and an impression cylinder 3, as one set of the essential constitutional elements. Any one of a reference numeral 9a in the printing unit 30a and a reference numeral 9 in each of the printing units 30b-30d is a transfer cylinder.

In each of the printing units 30a-30d, a printing plate 4 is mounted on the plate cylinder 1. Ink and water are supplied to this plate so that ink is transferred onto the rubber cylinder 2 through the printing plate. The ink transferred onto the rubber cylinder 2 is further transferred onto a printing sheet P, which is transferred thereto while being held between the rubber cylinder 2 and the impression cylinder 3. Whereby, each printing sheet P supplied from the sheet supply section 20 can be printed by the plates respectively provided on the plate cylinders 1. The plates 4 herein are to be able to print the basic color images of C, M, Y and Bk on each printing sheet P with a non-printing area set on the printing sheet P, and print a color bar (not illustrated) on the non-printing area.

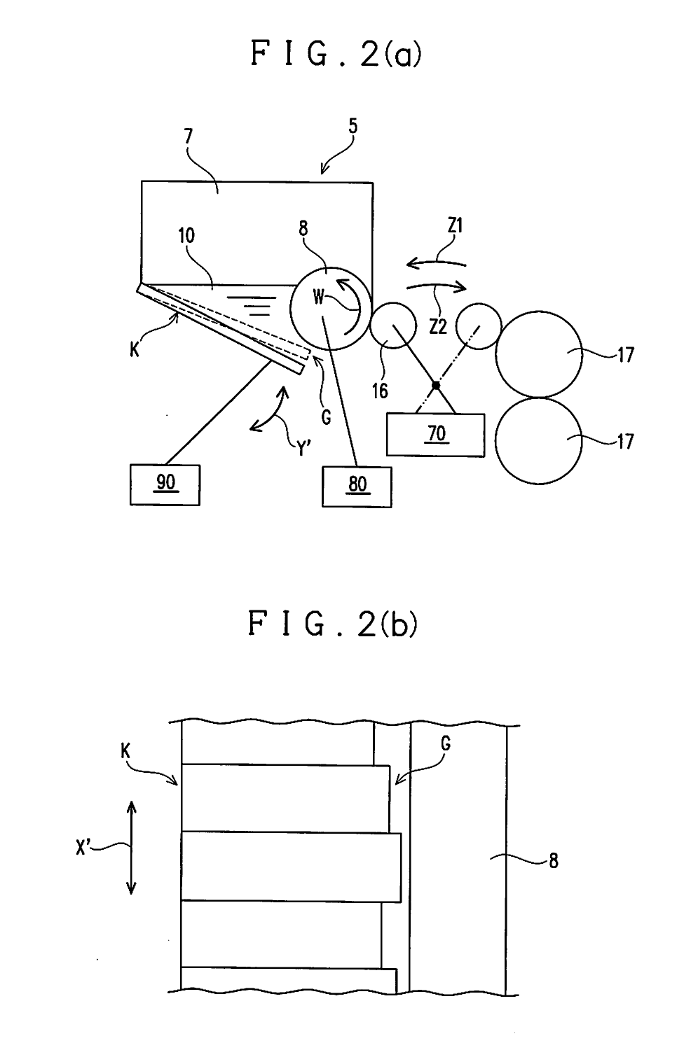

The printing units 30a-30d each include an ink supply device 5, a pivotally moving device 70 (omitted in FIG. 1, refer to FIG. 2(a) hereinafter described) and ink rollers (not illustrated in Figures), as well as the plate cylinder 1, the rubber cylinder 2 and the impression cylinder 3.

FIG. 2(a) is a model view illustrating an enlarged essential portion of the ink supply device 5 and its periphery, and FIG. 2(b) is a partial model view illustrating in exaggerated form a gap G between an ink fountain key and an ink fountain roller, which will be hereinafter-described, in the ink supply device 5. The ink supply device 5 can supply printing ink 10 to a printing plate 4 of the plate cylinder 4 via a group of ink rollers (not illustrated) in Figures.

The ink supply units 5 each include an ink fountain 7, an ink fountain roller 8, plural ink fountain keys K, a roller driving device 80 and an ink-fountain-key-moving device 90.

The ink fountains 7 each is capable of storing the printing ink 10, and is equipped with the ink fountain roller 8 and the plural ink fountain keys K. The ink fountain roller 8 is disposed so as to be rotatable at the bottom of the ink fountain 7 and is connected to the roller driving device 80. The roller driving device 80 is designed to be capable of drivingly rotating the ink fountain roller 8 in a predetermined direction (anti-clockwise direction W as represented by an arrow of FIG. 2(a)). Whereby, the ink fountain roller 8 can be drivingly rotated while attaching the printing ink 10 stored in the ink fountain 7 to the roller surface, thereby allowing the printing ink 10 on the roller surface to be supplied to the feed roll 16. Various conventional devices may be applied to the roller driving device 80, as long as they can drivingly rotate the ink fountain roller 8. Thus, a detailed description thereon will be herein omitted.

The plural ink fountain keys K are aligned adjacent to each other in a roller axis direction relative to the ink fountain roller 8 and in a lateral direction (represented by an arrow X′ in FIG. 2(b)) of the ink fountain key, and are projected to be movable in a moving direction (represented by an arrow Y′in FIG. 2(a)) crossing the lateral direction X′ of the ink fountain key. The ink fountain key K is connected to the ink-fountain-key-moving device 90 to be movable in the direction represented by this arrow Y′. Various conventional devices may be applied to this moving device, as long as they can move the plural ink fountain keys K in the moving direction Y′. Thus, a detailed description thereon will be herein omitted.

In the ink supply device 5 illustrated in FIG. 2(a), the printing ink 10 stored in the ink fountain 7 flows out through the gap G between the ink fountain roller 8 and the ink fountain key K, and is supplied onto the outer circumference of the ink fountain roller 8 when it is rotated. The gap G is adjustable by moving the ink fountain key K in the moving direction Y′ by the ink-fountain-key-moving device 90. As the opening degree of the ink fountain key K becomes large, the gap G is widened, thereby allowing the amount of ink to flow out from the ink fountain 7 to be increased. As the opening degree of the ink fountain key K becomes small, the gap G becomes narrower, thereby allowing the amount of ink to flow out from the ink fountain 7 to be decreased.

As illustrated in FIG. 2(a), the feed roller 16 is disposed to be pivotally movable between the ink fountain roller 8 and the ink roller 17, and is connected to the pivotally moving device 70 so as to bring itself close to the ink fountain roller 8 (move itself in a Z1 direction) or bring itself away from the ink fountain roller 8 towards the ink roller 17 (move itself in a Z2 direction), so that the feed roller 16 can be selectively located at a position close to the ink fountain roller 8 and a position close to the ink roller 17.

Thus, the printing ink 10 within the ink fountain 7 is moved from the ink fountain roller 8 to the ink roller 17 through the feed roller 16, and is supplied onto the printing plate 4 via the group of ink rollers.

According to the thus arranged printing section 30, four color printing inks C, M, Y and Bk are respectively stored in the four ink fountains 7, in which the plural ink fountain keys K are installed in the lateral direction X′ of the ink fountain key so as to be able to each adjust the amount of corresponding ink to be supplied, and the plural basic color inks whose amounts to be supplied are each adjusted by the corresponding ink fountain key K are supplied to the four printing plates 4 which respectively form the basic color images of C, M, Y and Bk provided corresponding to the ink fountains 7.

Although not illustrated, a color bar for controlling the quality of the color print image printed on the surface of the printed matter Q at the printing section 30 of the color printing press 100 of FIG. 1 has four patches for solid density control and one patch for gray control, which are printed in this order. The four solid-density-controlling patches are solid-density-controlling patches with tone values of 100% printed by C-ink, M-ink, Y-ink and Bk ink, respectively formed corresponding to the basic color images of C, M, Y and Bk. The one gray-controlling patch is formed by overlapping together halftone images of predetermined halftone values of C, M and Y, which respectively correspond to the C, M and Y basic color images of the C, M, Y and Bk basic color images.

The four solid-density-controlling patches are scanned by a scanner equipped with a spectrophotometer (not illustrated), which enables measuring the spectral densities of the four solid-density-controlling patches of the color bar of the printed matter Q, as well as measuring the spectral densities of the C, M, Y and Bk components composing the gray-controlling patch. Thus, the solid-density control and the gray control can be simultaneously performed by transmitting the measured values of the spectral densities of the four solid-density-controlling patches and the spectral densities of the C, M and Y components composing the gray-controlling patch to the control section S.

The control section S, which can simultaneously perform the solid density control and the gray control, is illustrated in a block diagram of FIG. 3.

This control section S includes a target-value-input means 11 for inputting plural (four) target solid densities as targets for checking the densities of ink colors of a color print image to be printed and a target gray balance data (gray balance value) as a target for checking the gray balance of the color print image; a measuring means 12 for measuring plural (four) solid densities and gray balance, of a printed color print image; a computing means 13 for computing the difference between four solid density values measured by the measuring means 12 and the four target solid density differences inputted by the target-value-input means 11 and computing the difference between the gray balance value and the target gray balance value inputted by the target-value-input means 11; a correction-value-computing means for computing the correction value based on the four solid density differences computed by this computing means 13 and the gray balance difference, that is, a correction-solid-density-difference-computing means 14 for computing the correction solid density difference; and an ink-supply-amount-adjusting means for adjusting the amount of ink to be supplied by each of the plural ink fountain keys. Herein, for realizing the target-value-input means 11, in addition to inputting into the control section S by using a keyboard or the like, it is possible to employ allowing data stored in a recording medium, such as a magnetic disc, to be read by the control section S, or to be written into the same, and allowing data stored in a personal computer or the like to be read by the control section S via the Internet or by using a transmission medium, such as cable, or to be written into the same. The gray balance is meant a balance between the colourants and is used to correct the color balance. As will be mentioned later, the color balance is corrected by adjusting the amount of ink of each of the basic colors C, M, Y and Bk.

In more detail, according to the apparatus for controlling the quality of printed images, the gray balance value is a Lab value of gray and the computing means 13 is provided with a computing means for solid density control that computes the difference between the four solid density values measured by the measuring means 12 and the four target solid density values inputted by the target-value-input means 11, and a computing means for gray control that computes the difference between the measured one gray balance value and the one target gray balance value. The latter computing means is a ΔLΔaΔb computing means 18 for respectively computing ΔL, Δa and Δb, based on the difference between the target Lab value and the Lab value at the time when the printed color print image was measured, in which ΔL represents brightness, and Δa and Δb respectively represent hues. The correction-solid-density-difference-computing means 14 is provided with a halftone-density-difference-converting means 19 for converting the three ΔL, Δa and Δb computed by the ΔLΔaΔb computing means 18 respectively into the halftone density differences; a solid-density-difference-converting means 21 for converting the three halftone density differences converted by the halftone-density-difference-converting means 19 respectively into the solid density differences; and an average-value-computing means 22 for computing, as the correction solid density difference, the average of the sum of the values of the three solid density differences for gray control converted by the solid-density-difference-converting means 21 and the four solid density differences for solid density control computed by the computing means 13.

The halftone-density-difference-converting means 19 is provided with a first converting means for converting the value of Δb into the halftone density difference; a second converting means 24 for converting the fluctuation amount Δa′ of Δa corresponding to the fluctuation amount of Δb into the halftone density difference relative to Δa1 added to the Δa; and a third converting means 25 for converting ΔL into the halftone density difference converted by the first converting means 23 and the second converting means and converting ΔL determined from the relationship between the halftone density differences and the equivalent halftone density difference. Although the description herein is made for the apparatus for controlling the quality of printed images, it may be applicable to the method of controlling the quality of printed images using this apparatus. Thus, the description for the latter will be omitted.

A solid-density-controlling means is generally a means for controlling the amount of each of the basic color inks respectively supplied from the ink fountains 7 by the ink fountain keys K, based on the solid densities of the four basic color images of C, M, Y and Bk, which together compose a color print image. Accordingly, as mentioned above, in the solid-density-controlling means, four target densities of C, M, Y and Bk respectively corresponding to the four basic color images of C, M, Y and Bk are previously inputted (stored) in the control section S by the target-value-input means 11; the solid densities for the solid-density-controlling patches of C, M, Y and Bk of a printed sheet are respectively measured by using a density controlling system or the like (not illustrated); and the ink-fountain-key-moving device 90 is driven to vary the gaps G of the ink fountain keys K to bring the solid densities of the measured four solid-density-controlling patches at the four target densities of C, M, Y and Bk previously inputted. Thus, the amount of each of the basic color inks of C, M, Y and Bk respectively supplied from the ink fountains 7 of C, M, Y and Bk can be controlled. However, in this control, the gray control is completely disregarded and therefore the printed gray balance may sometimes fall out of the set range.

A gray controlling means is generally a means for controlling the amount of each of the three basic color inks of C, M and Y respectively supplied from the ink fountains 7 based on the gray balance between the basic color images of C, M and Y (Bk is controlled based on the solid density). Accordingly, in the gray controlling means, the standard spectral densities of C, M and Y respectively corresponding to the basic color images of C, M and Y are previously set; and the spectral densities for the gray control patch respectively corresponding to the basic color images of C, M and Y are measured by using a density controlling system or the like. Then, the ink-fountain-key-moving device 90 is driven to vary the gaps G of the ink fountain keys K to bring the spectral densities of C, M and Y for the measured gray control patch at the previously set standard spectral densities of C, M and Y. Thus, the amount of each of the basic color inks of C, M and Y respectively supplied from the ink fountains 7 of C, M and Y can be controlled. However, in this control, the solid density control is completely disregarded and therefore a printed solid density value may sometimes fall out of the set range.

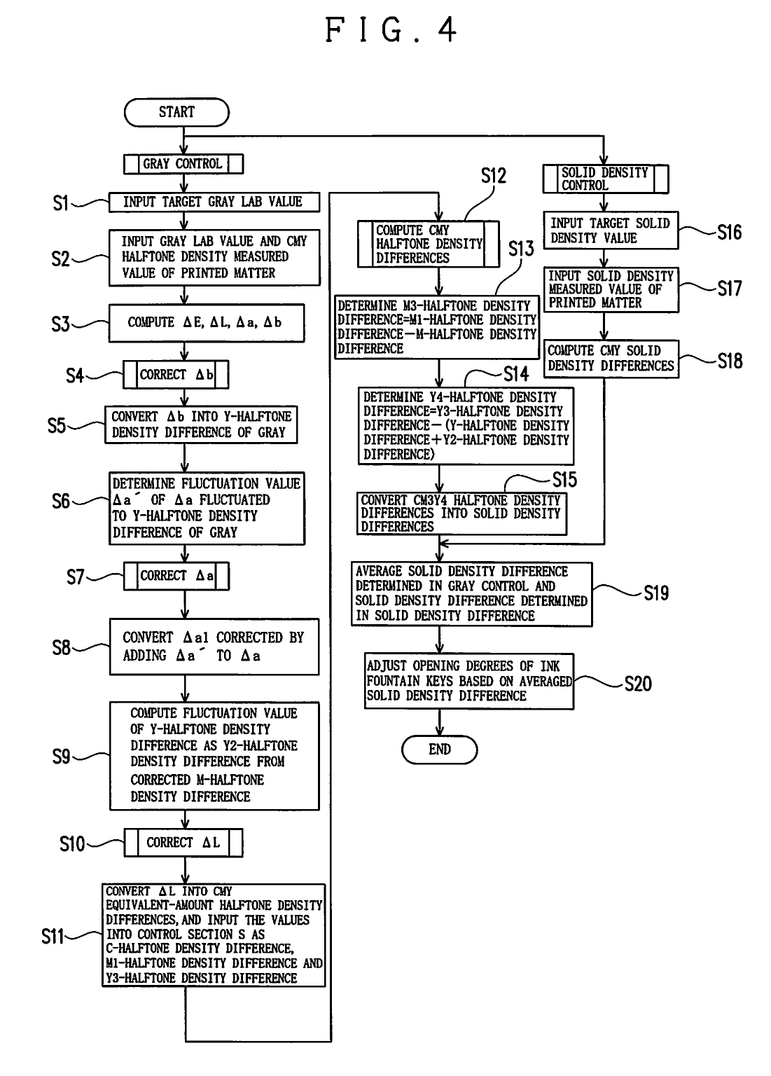

A print control means is a means for controlling the quality of a color print image, based on a total of seven data of four data determined by the solid-density-controlling means and three data determined by the gray controlling means for each of the ink fountain keys K, which will be described with reference to the flowchart of FIG. 4.

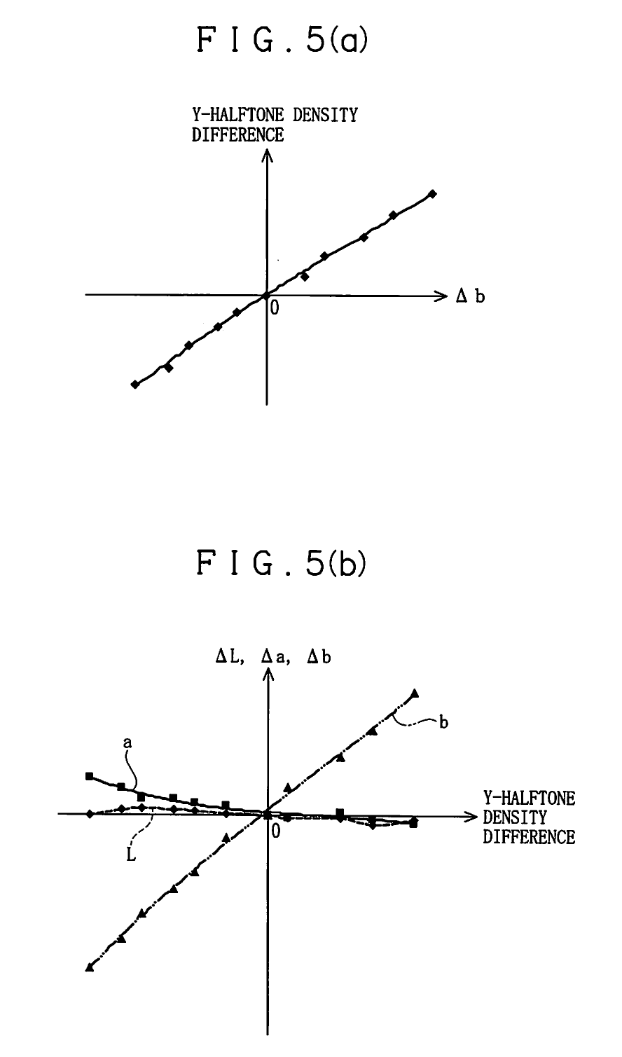

In gray control, target gray Lab values (three values) are inputted into the control section S (Step S1). The target gray Lab values may be Lab values previously selected and designated, or measured values when sample gray Lab was measured. After inputting the three target values, gray Lab values and CMY halftone density values, of the gray density controlling patch of a printed matter (herein, a printed sheet) printed by driving the printing press are measured by a scanner or the like and these six measured values are inputted into the control section S (Step S2). Then, based on the differences between the target gray Lab values and the sample gray Lab measured values, the color difference ΔE, the brightness (lightness) ΔL, and the hues Δa of red and green and the hues Δb of yellow and blue, of the hues, are computed (Step S3). Subsequent to the computation of them, a subroutine for performing the correction of Δb is executed (Step S4), and Δb is converted into the Y-halftone density difference of gray (Step S5). For converting Δb into the Y-halftone density difference of gray, a graph showing the relationship between Δb and the Y-halftone density difference is presented in FIG. 5(a), and a line of the graph is previously converted into an expression and the value of Δb is plugged into this expression so that the Y-halftone density difference can be computed. Then, the fluctuation amount Δa′ of Δa fluctuated relative to the computed Y-halftone density difference of gray is determined (Step S6). This fluctuation amount Δa′ can be computed by converting three lines of a graph showing the relationship between the Y-halftone density difference and ΔLΔaΔb, namely a line L (represented by broken line), a line a (represented by solid line) and a line b (represented by chain double-dashed line) of FIG. 5(b) into expressions and then plugging the Y-halftone density difference into the expressions.

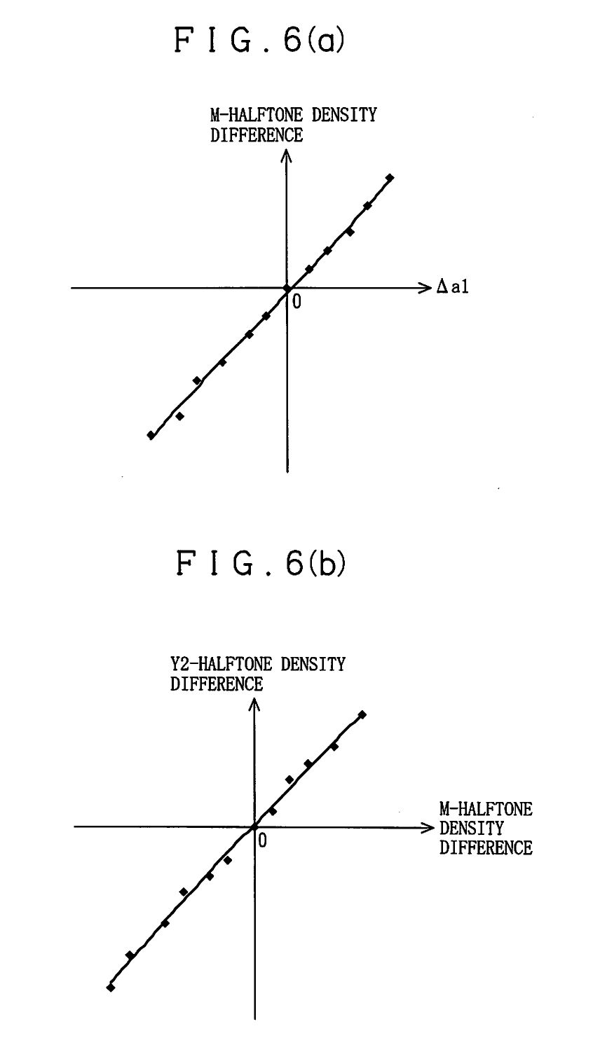

Then, the method proceeds to a subroutine for performing the correction of Δa (Step S7). Δa1 corrected by adding the fluctuation amount Δa′ determined in Step S6 to Δa determined in Step S3 is converted into the M-halftone density difference of gray (Step S8). A graph showing the relationship of the M-halftone density difference relative to Δa1 is illustrated in FIG. 6(a), in which a line of the graph is converted into an expression and then the value of Δa1 is plugged into this expression. Thus, the M-halftone density difference can be computed. The fluctuation amount of the Y-halftone density difference is computed as the Y2 halftone density difference from the corrected M-halftone density difference (Step S9). A graph showing the relationship of the Y2-halftone density difference relative to the M-halftone density difference is illustrated in FIG. 6(b), in which a line of the graph is converted into an expression and then the value of the M-halftone density difference is plugged into this expression. Thus, the Y2-halftone density difference can be computed. As mentioned above, since it is possible to correct to the difference, to which the fluctuation amount Δa′ relative to Δa corresponding to the fluctuation amount of Δb, that is, correct into the M-halftone density difference, there is an advantage in that the M-halftone density difference can be calculated with high accuracy as compared with an arrangement in which the difference is calculated by a uniformly defined value.

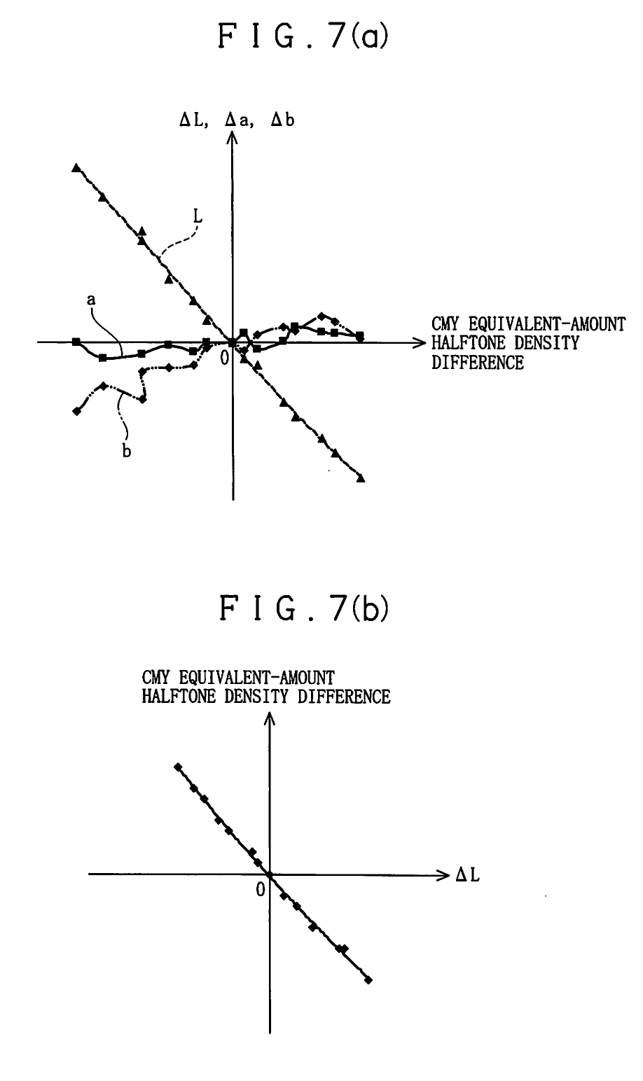

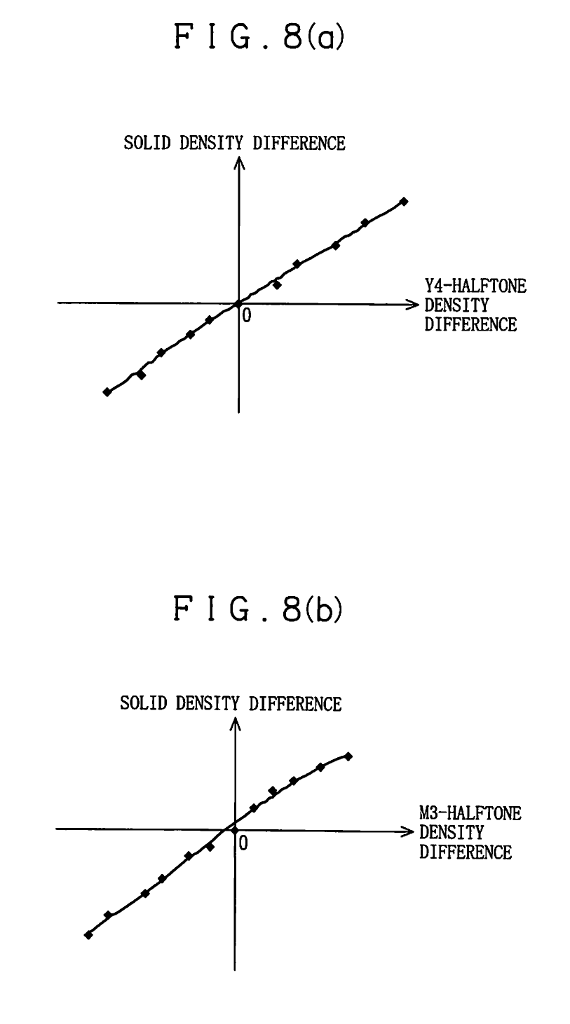

Then, the method proceeds to a subroutine for performing correction of ΔL (Step S10). In this step, ΔL is converted into the CMY equivalent amount-halftone density differences of gray, and those values are inputted into the control section S as the C-halftone density difference, the M1-halftone density difference and the Y3-halftone density difference (Step S11). This is represented in a graph of FIG. 7(a) that shows the relationship of ΔL (represented by broken line), Δa (represented by solid line) and Δb (represented by chain double-dashed line) relative to the CMY equivalent amount-halftone density differences, in which the lines of the graph are converted into expressions and then the CMY equivalent amount-halftone density differences are plugged into these expressions. Thus, the values of ΔL, Δa and Δb are computed. A graph showing the relationship of the CMY equivalent amount-halftone density differences relative to ΔL, among them, is illustrated in FIG. 7(b), in which a line of the graph is converted into an expression and then ΔL is plugged into this expression. Thus, the CMY equivalent amount-halftone density differences can be computed. Then, the method proceeds to a subroutine for computing the CMY equivalent amount-halftone density differences (Step S12). The M3-halftone density is determined by subtracting the M-halftone density difference determined in Step S8 from the M1-halftone density difference determined in Step S11 (Step S13). Then, a value resulting from subtracting the Y-halftone density difference determined in Step S5 and the Y2-halftone density difference determined in Step S9 from the Y3-halftone density difference determined in Step S11, is designated as the Y4-halftone density difference (Step S14). The sum of three halftone density differences, namely the C-halftone density difference determined in Step S11, the M3-halftone density difference determined in Step S13 and the Y4-halftone density difference determined in Step S14 are respectively converted into solid density differences and then the gray control is finished (Step S15). Converting the three halftone density differences into solid density differences is made based on a graph of FIG. 8(a) showing the solid density difference relative to the Y4-halftone density difference and a graph of FIG. 8(b) showing the solid density difference relative to the M3-halftone density difference. It is to be noted that the solid density difference relative to the C-halftone density difference is omitted herein.

In a routine in which the solid density control is performed in parallel with the gray control, the four target solid density values of the basic color inks of C, M, Y and Bk are inputted into the control section S (Step S16). Subsequent to inputting the four target solid density values, the solid density values of four patches for the solid density control of a printed matter (herein, a printed sheet) printed by driving the printing press are respectively measured by a scanner or the like and those four measured values are inputted into the control section S (Step S17). Then, the CMY solid density differences are respectively computed from the differences between the four target solid density values and four sample solid density values and thus the solid density control is finished (Step S18).

Then, an average process for averaging the three solid density differences determined in the gray control and the four solid density differences determined in the solid density control is performed, and specifically both are added together and is divided by seven to yield a value, which is designated as a correction value (Step S19). Then, the opening degree values of the ink fountain keys are extracted from a table in which the correction solid density difference, that is, the averaged correction value is previously stored, thereby adjusting the opening degrees of the ink fountain keys (Step S20). Thus, the control is finished. Herein, an average value of the three solid density differences determined in the gray control and the four solid density differences determined in the solid density control is determined. However, any value may be optionally set, as long as it does not fall out of the appropriate range of the three solid density differences previously set by the three solid density differences determined in the gray control and dose not fall out of the appropriate range of the four solid density differences previously set by the four solid density differences determined in the solid density control. It is to be noted that various graphs illustrated in Figures merely represent an example of the embodiment without intention to limit the present invention to the illustrated graphs.

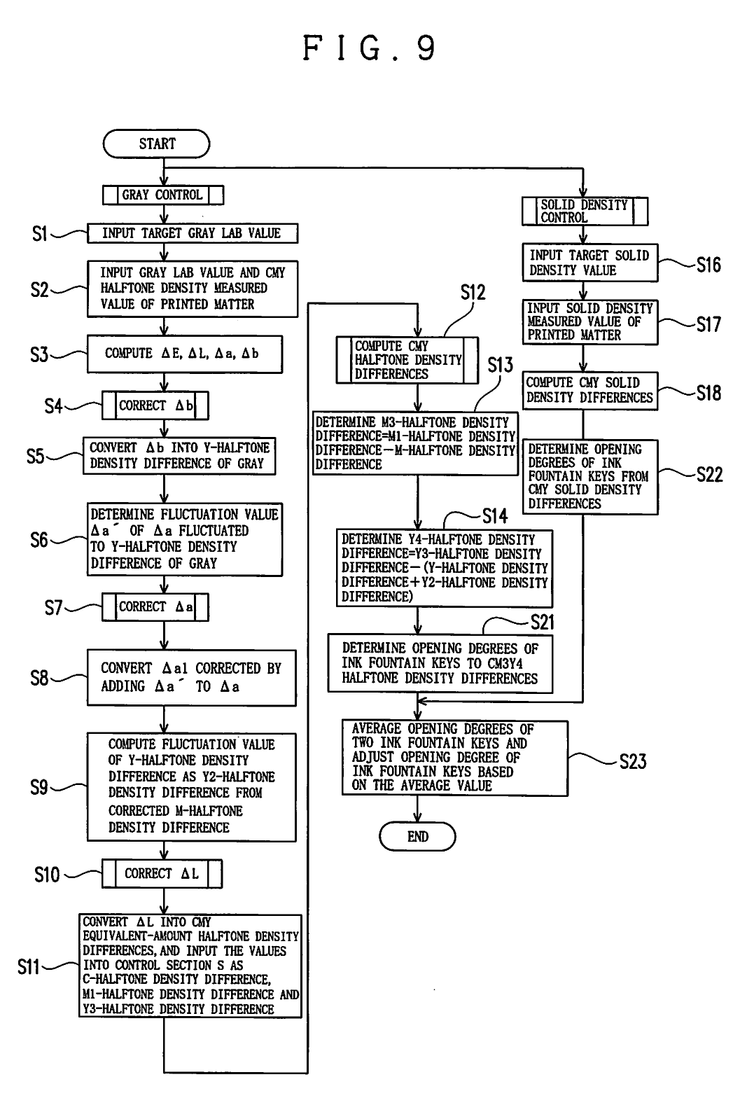

In FIG. 4, the three halftone density differences determined in the gray control are respectively converted into the solid density differences, and the converted three solid density differences and the four solid density differences determined in the solid density control are summed and averaged, so that there is an advantage in that a single table is enough to deal with the correction solid density differences, that is, the correction values. However, as illustrated in FIG. 9, two tables may be utilized. The description will be hereinafter made only for the differences between FIG. 4 and FIG. 9. In the gray control, after determination of the Y4-halftone density difference in Step S14, the values of the ink fountain keys corresponding to the CM3Y4-halftone density differences are determined from a table in which the corresponding values are previously stored therein (Step S21). In the solid density control, after computing the CMY-solid density differences in Step S18, the opening degrees of the ink fountain keys are determined based on the CMY-solid density differences from a second table in which the corresponding opening degrees are previously stored (Step S22). The opening degrees of the ink fountain keys determined in the gray control and the opening degrees of the ink fountain keys determined in the solid density control are averaged, and specifically, the two different opening degrees of each ink fountain key are summed and divided into a half to yield an average value (correction value), by which the opening degree of the ink fountain key is adjusted (Step 823). Thus, the control is finished. A series of these processes are automatically performed by the control section S.

This specification is by no means intended to restrict the present invention to the preferred embodiments set forth therein. Various modifications to the method of controlling the quality of printed images of a color printing press by controlling respectively the amounts of inks of basic inks, and the apparatus for controlling the quality of printed images, as described herein, may be made by those skilled in the art without departing from the spirit and scope of the present invention as defined in the appended claims.

What is claimed is:

1. A method of controlling the quality of printed images of a color printing press comprising:
adjusting by using ink fountain keys the amounts of printing inks of plural basic colors different from each other to be supplied from plural ink fountains with the printing inks stored therein;
supplying the basic color inks adjusted respectively by the ink fountain keys on plural printing plates provided corresponding to the plural ink fountains; and
printing successively plural basic color images formed respectively by the plural basic color inks onto a substrate, thereby printing a color print image on the substrate, said method further comprising:
measuring the solid densities of the plural basic color images, respectively, and measuring the gray balance for use in correcting the color balance between the plural basic color images;
computing the differences between the measured plural solid density values and preset plural target solid density values and computing the difference between the measured gray balance value and a preset target gray balance value; and
adjusting the amount of the ink of each of the basic colors to be supplied by each of the plural ink fountain keys.

2. The method of controlling the quality of printed images of a color printing press according to claim 1, further comprising:
computing the brightness ΔL, and the hues Δa and Δb from a target Lab value and a Lab value obtained by measuring a printed color print image, by using a gray Lab value as a gray balance value;
converting the computed three ΔL, Δa and Δb respectively into halftone density differences and then converting the converted three halftone density differences respectively into solid density differences;
summing the converted three solid density differences for the gray control and the plural solid density differences for the solid density control computed from the measured plural solid density values and the plural target solid density values and averaging the summed values to yield average values; and
adjusting the amount of the ink of each of the basic colors to be supplied through each of the plural ink fountain keys, based on the computed average values.

3. An apparatus for controlling the quality of printed images of a color printing press comprising:
plural ink fountains for respectively storing printing inks of plural basic colors different from each other; and
plural ink fountain keys for each adjusting the amount of each of the printing inks to be supplied from the ink fountains;
wherein the basic color printing inks whose ink supply amounts each adjusted by each ink fountain key are respectively supplied onto plural printing plates provided corresponding to the plural ink fountains, and plural basic color images respectively formed with the plural basic color inks by the plural printing plates are successively printed on a substrate, thereby printing a color print image on the substrate;
the apparatus further comprising a control section, said control section including:
a measuring means for measuring the solid densities of the plural basic color images, respectively, and measuring the gray balance for use in correcting the color balance between the plural basic color images;
a computing means for computing the differences between the plural solid density values measured by the measuring means and preset plural target solid density values and computing the difference between the gray balance measured by the measuring means and a preset target gray balance value;
a correction-value-computing means for computing the correct values based on the plural solid density differences computed by the computing means and the gray balance difference; and
an ink-supply-amount-adjusting means for adjusting the amount of the ink of each of the basic colors to be supplied through each of the plural ink fountain keys, based on the correction values computed by the correction-value-computing means.

4. The apparatus for controlling the quality of printed images according to claim 3, wherein:
the gray balance value is a gray Lab value;
the computing means for gray control for computing the difference between the measured gray valance value and the target gray balance value is a ΔLΔaΔb computing means for computing the brightness ΔL, and the hues Δa and Δb from the difference between a target Lab value and a Lab value obtained by measuring a printed color print image;
the correction-value-computing means is a correction-solid-density-difference-computing means for computing the correction solid density difference;
the correction-solid-density-difference-computing means includes:
a halftone-density-difference-converting means for converting the three ΔL, Δa and Δb computed by the ΔLΔaΔb computing means respectively into halftone density differences;
a solid-density-difference-converting means for converting the three halftone density differences converted by the halftone-density-difference-converting means respectively into solid density differences; and
an average-value-computing means for summing the three solid density differences for the gray control converted by the solid density-difference converting means and the plural solid density differences for the solid density control computed by the computing means, and averaging the sum to yield average values designated as correction solid density differences.
